(19) United States
(12) Patent Application Publication
(10) Pub. No.: US 2016/0092470 A1
(43) Pub. Date: Mar. 31, 2016

(54) VISUALIZATION OF ADDRESSES

(71) Applicant: International Business Machines Corporation, Armonk, NY (US)

(72) Inventors: Billy W. Chang, Rockville, MD (US); Sarbajit K. Rakshit, Kolkata (IN)

(21) Appl. No.: 14/714,586

(22) Filed: May 18, 2015

Related U.S. Application Data
(63) Continuation of application No. 14/501,567, filed on Sep. 30, 2014.

(51) Int. Cl. G06F 17/30; G06T 11/60; G06T 11/20

(52) U.S. Cl. CPC G06F 17/30241; G06F 17/30477; G06F 17/30528; G06F 17/30247; G06T 11/206; G06T 11/60

(57) ABSTRACT

Provided are techniques for visualization of addresses. Search criteria for an entity is received. One or more addresses for the entity are identified based on the search criteria. For each of the one or more addresses, a floor associated with the entity at that address is identified, related information for the floor that includes photographs of views seen from that floor are identified, and, on a 2-dimensional (2-D) electronic map, a 3-dimensional (3-D) structure that indicates the floor and provides access to the related information is plotted.

### FIELD

Embodiments of the invention relate to visualization of addresses. In particular, embodiments of the invention relate to visualization of three-dimensional (3-D) addresses in a two-dimensional (2-D) electronic map.

### BACKGROUND

Map systems allow users to search for an address. The map systems typically list possible addresses, along with a two-dimensional (2D) electronic map displaying indicators for those possible addresses. In some cases, the address may be for a building having multiple floors.

For example, a user may search for an office address in the electronic map by entering “Airline Office”. The map system in this example returns a list of possible addresses, with some of the addresses being for different floors of a building. Continuing with the example, one address is provided for an office on the seventh floor as: “7^{th} floor, One Citygate”. The map system plots the possible addresses on a two-dimensional map.

Some map systems provide a three-dimensional (3D) map, which provides an image of a building with, for example, the building's name.

### SUMMARY

Provided is a method for visualization of addresses. The method comprises: receiving, using a processor of a computer, search criteria for an entity; identifying one or more addresses for the entity based on the search criteria; for each of the one or more addresses, identifying a floor associated with the entity at that address, identifying related information for the floor that includes photographs of views seen from that floor, and plotting, on a 2-dimensional (2-D) electronic map, a 3-dimensional (3-D) structure that indicates the floor and provides access to the related information.

Provided is a computer program product for visualization of addresses. The computer program product comprising a computer readable storage medium having program code embodied therewith, the program code executable by at least one processor to perform: receiving, by the at least one processor, search criteria for an entity; identifying, by the at least one processor, one or more addresses for the entity based on the search criteria; for each of the one or more addresses, identifying, by the at least one processor, a floor associated with the entity at that address, identifying, by the at least one processor, related information for the floor that includes photographs of views seen from that floor, and plotting, by the at least one processor, on a 2-dimensional (2-D) electronic map, a 3-dimensional (3-D) structure that indicates the floor and provides access to the related information.

Provided is a computer system for visualization of addresses. The computer system comprises: one or more processors, one or more computer-readable memories and one or more computer-readable, tangible storage devices; and program instructions, stored on at least one of the one or more computer-readable, tangible storage devices for execution by at least one of the one or more processors via at least one of the one or more memories, to perform operations, the operations comprising: receiving search criteria for an entity; identifying one or more addresses for the entity based on the search criteria; for each of the one or more addresses, identifying a floor associated with the entity at that address, identifying related information for the floor that includes photographs of views seen from that floor, and plotting, on a 2-dimensional (2-D) electronic map, a 3-dimensional (3-D) structure that indicates the floor and provides access to the related information.

### BRIEF DESCRIPTION OF THE SEVERAL VIEWS OF THE DRAWINGS

In the drawings, like reference numbers represent corresponding parts throughout.

FIG. 1 illustrates, in a block diagram, a computing environment in accordance with certain embodiments.

FIG. 2 illustrates 3-D structures representing addresses in a 2-D electronic map in accordance with certain embodiments.

FIG. 3 illustrates, in a flow diagram, operations for plotting 3-D structures in accordance with certain embodiments.

FIG. 4 illustrates, in a flow diagram, operations performed to obtain related in formation in accordance with certain embodiments.

FIG. 5 illustrates, in a flow diagram, operations performed to provided related information in accordance with certain embodiments.

FIG. 6 illustrates, in a block diagram, a computer architecture that may be used in accordance with certain embodiments.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

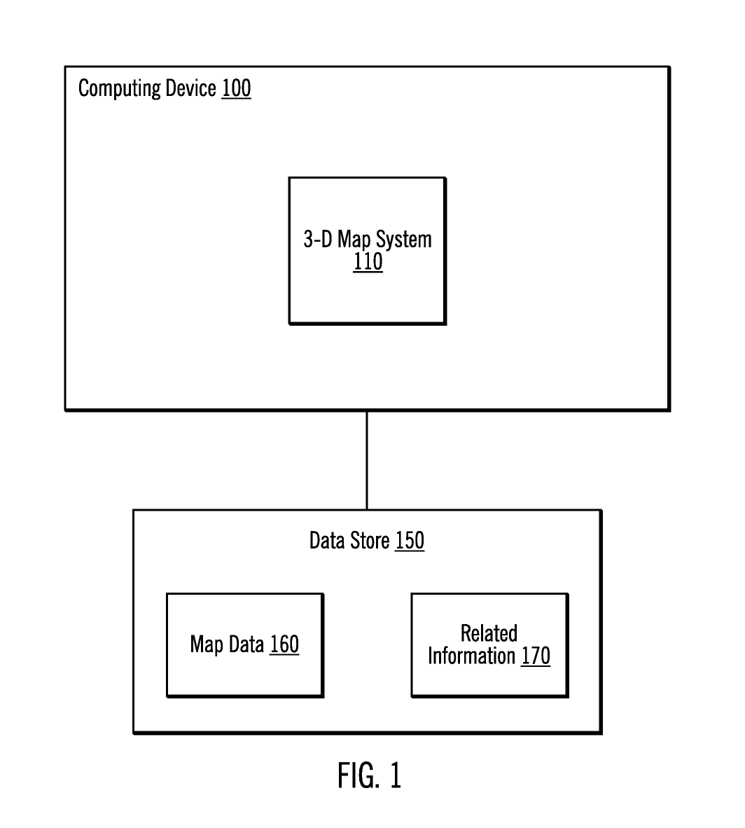

FIG. 1 illustrates, in a block diagram, a computing environment in accordance with certain embodiments. A computing device 100 is coupled to a data store 150. The computing device 100 includes a 3-D map system 110. The data store 150 includes map data 160 and related information 170 (e.g., photographs). In certain embodiments, the map data 160 includes geographic maps, street/road information, address information, building information, mountain range information, bodies of water information, and other map information.

With embodiments, the 3-D map system 110 enables a user to visualize the location of an entity based on the height of an office floor in a building. The 3-D map system 110 also provides views from that office floor (at that height). An entity may be a company, an individual, etc.

In certain embodiments, the 3-D map system 110 receives a list of possible addresses for an entity based on a user's search criteria. The user's search criteria may specify a building name, an individual's name, an address, a partial address, etc. Then, the 3-D map system 110 plots the addresses with a 3-D block in a 2-D electronic map. This helps the user to find the relative height of the address in the 2-D electronic map.

In certain embodiments, if the user's search criteria does not provide a floor (of a building or other structure) and the list of possible addresses do not specify floors, the 3-D map system 110 performs a search (e.g., an internet search, an intranet search, search of an address data store, and/or search of a map database, etc.) to obtain floors for the addresses. At the same time, the 3-D map system 110 analyzes street view data to find floors of a building or other structure. Street view data may be described as images (e.g., panoramic views) taken from a street level. Moreover, image analysis data may be used for identifying a floor number. In certain embodiments, the 3-D map system 110 searches (e.g., the internet, the intranet, the address data store, and/or the map database, etc.) for a building name (e.g., based on a user's search criteria), then, the 3-D map system 110 uses the building name in another search query to obtain additional information about the building (e.g., floor information). Then, the floor information is plotted on a 2-D electronic map.

The 3-D map system 110 may also display associated information with the electronic map, such as the location of an elevator in the building, views that are available from the identified height, etc.

In certain embodiments, a user may select a view from a list of views, and the 3-D map system 110 displays the selected view.

In certain embodiments, a user may select a view angle, and, accordingly from the view point of that view angle, the 3-D map system 110 displays any photographs captured. For example, a user selects a 3-D structure and a direction, and the 3-D map system 110 provides views from that height.

Also, with embodiments, the user may provide search criteria specifying height. For example, height criteria may be provided as: “should be between 5th to 10th floor”.

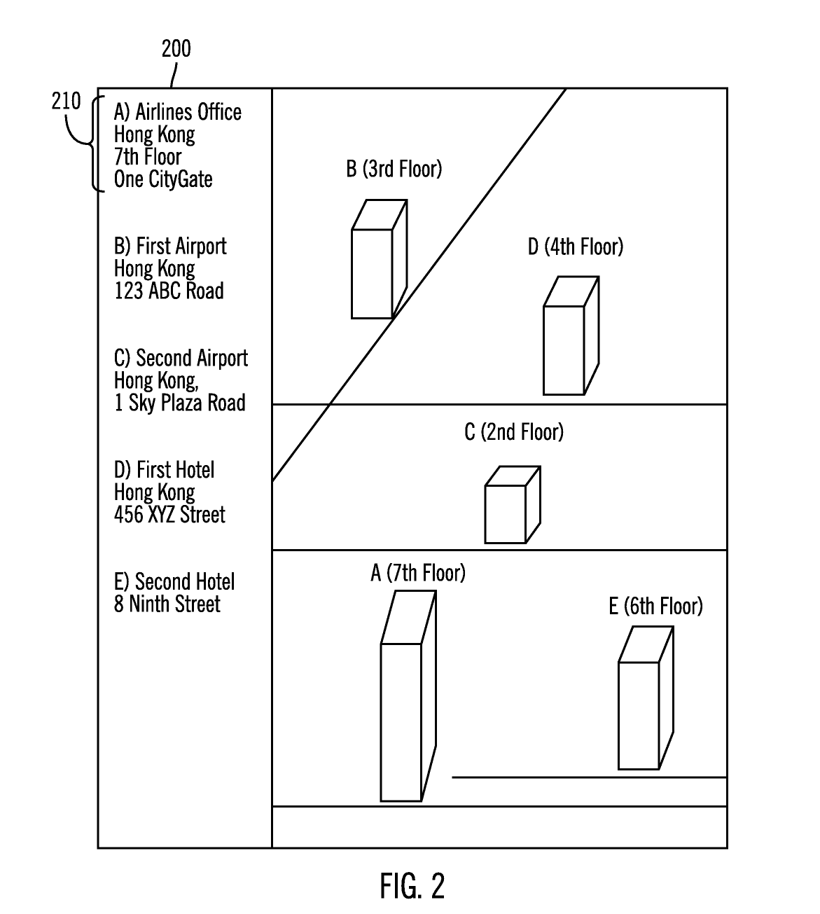

FIG. 2 illustrates 3-D structures representing addresses in a 2-D electronic map in accordance with certain embodiments. In FIG. 2, a list of addresses 200 is provided in response to a user search query. The addresses may be for office buildings, apartment buildings, schools, and other structures. In certain embodiments, it is possible to find the same office on different floors (of a building or other structure). Also, from the list of addresses for a building, it is possible that one or more addresses include a floor for the building. For example, only one of the addresses, address 210, includes a floor in FIG. 2. However, for all of the addresses, the 3-D map system 110 plots the address with a 3-D structure representing that address. In certain embodiments, the 3-D structure appears to be three-dimensional.

In certain embodiments, each 3-D structure has a height, width, and length. The height is plotted based on the actual height of buildings at the address so that a shorter building is shown with a 3-D structure having a shorter height than a taller building. For example, the 3-D structure for address A, which has 7 floors, is taller than the 3-D structure for building B, which has 3 floors.

Also, each 3-D structure is displayed with a floor number. If the address includes a floor number, the 3-D structure is displayed with that floor number. In certain embodiments, if the address does not include a floor number, then the 3-D map system 110 uses searches and/or street view data to identify the floor. Such 3-D structures help the user to visualize the address and height of the address.

For example, in any city, there may be multiple offices of a company/organization. Say, a telephone company office is in 8 different location of the city, at different floors. So, while searching the address, the floor number will be shown graphically so that user can easily understand/visualize the height difference and select. For example, if one user does not want to climb high or has a fear of heights, that user may select a low height office based on the 3-D map.

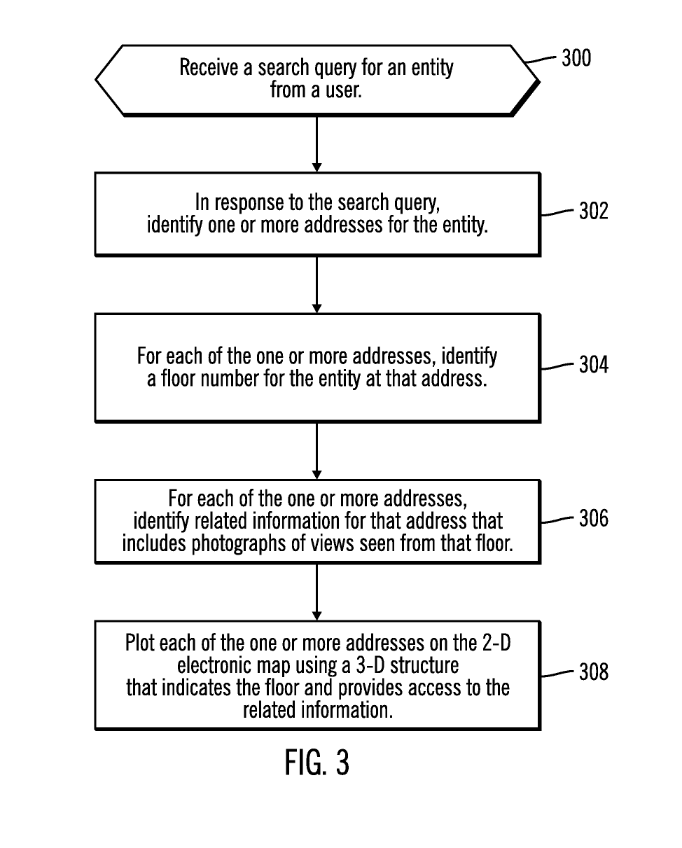

FIG. 3 illustrates, in a flow diagram, operations for plotting 3-D structures in accordance with certain embodiments. Control begins at block 300 with the 3-D map system 110 receiving a search query for an entity (e.g., a company or a person) from a user. In block 302, in response to the search query, the 3-D map system 110 identifies one or more addresses for the entity. In block 304, for each of the one or more addresses, the 3-D map system 110 identifies a floor number for the entity at that address (where the floor is for a building or other structure at a particular address). For example, in block 304, the 3-D map system 110 performs a search (e.g., an internet search, an intranet search, search of an address data store, and/or search of a map database, etc.) to attempt to identify the floor number for that entity at each of the one or more addresses. In certain embodiments, a floor number may not be found for the entity at a particular address, and the 3-D map system 110 may show the address as ground floor with a notification “no information is found”. In certain embodiments, a multiple floor numbers may be found for the entity at a particular address, and the 3-D map system 110 may either select one of the floors (e.g., selecting a lowest floor from the floors, selecting a highest floor from the floors, etc.) for plotting the 3-D structure or plot all of the floors for the 3-D structure.

In block 306, for each of the one or more addresses, the 3-D map system 110 identifies related information for that address that includes photographs of views seen from that floor. In certain embodiments, the 3-D map system 110 searches social networking sites, other internet sites, databases, and other data sources to identify the related information. In certain embodiments, the related information includes location of elevators, locations of stairways, location of doors, entryway, view from the height, etc.

In certain embodiments, the related information includes photographs of views that may be seen outside the building while on the floor inside that building. In certain embodiments a camera has a compass, and the camera captures metadata of the photograph, such as direction (e.g., East), and this information is used to determine whether a particular photograph represents a view from a particular floor of a building.

In block 308, the 3-D map system 110 plots each of the one or more addresses on the 2-D electronic map using a 3-D structure that indicates a height at that address and provides access to the related information. In certain embodiments, the 3-D map system 110 provides a related information indicator for each 3-D structure. In certain embodiments, this 2-D electronic may with 3-D structures and related information indicators is displayed to a user on an output device (e.g., a computer screen). In certain embodiments, this 2-D electronic may with 3-D structures and related information indicators is stored (e.g., as map data 160). In response to receiving selection of the related information indicator (e.g., by a user clicking on the related information indicator using an input device, such as a mouse), the related information is provided (e.g., via a pop-up box, overlaid on the map, etc.).

In certain embodiments, if the user has provided a height in the search criteria, the 3-D map system 110 identifies the one or more addresses based on the height designated. Thus, the height in the search criteria may be used as search criteria and/or as a filter.

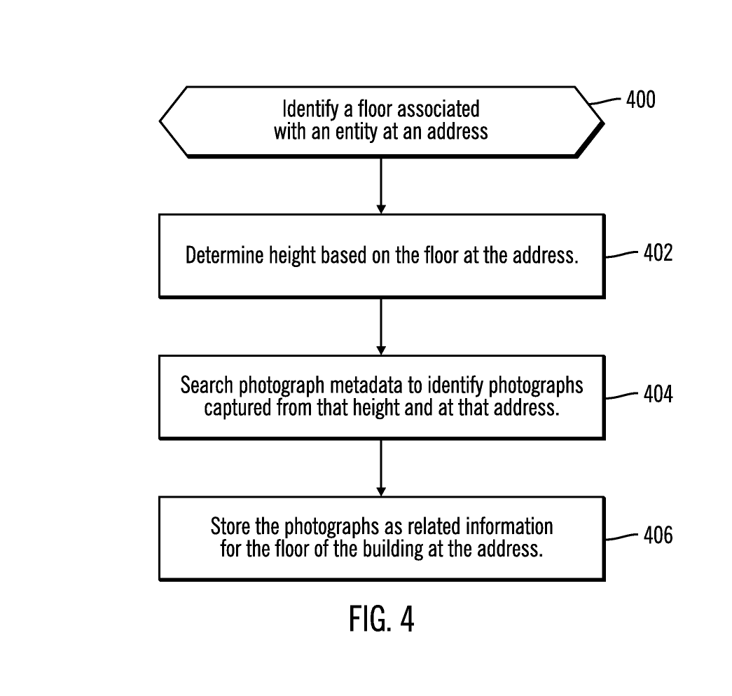

FIG. 4 illustrates, in a flow diagram, operations performed to obtain related in formation in accordance with certain embodiments. Control begins at block 400 with the 3-D map system 110 identifying a floor associated with an entity at an address. In block 402, the 3-D map system 110 determines height based on the floor at the address. In certain embodiments, the height may be found in a data store storing information about the building at the address. In block 404, the 3-D map system 110 searches photograph metadata (e.g., stored in a data store) to identify photographs captured from that height and at that address. In block 406, the 3-D map system stores the photographs as related information for the floor of the building at the address.

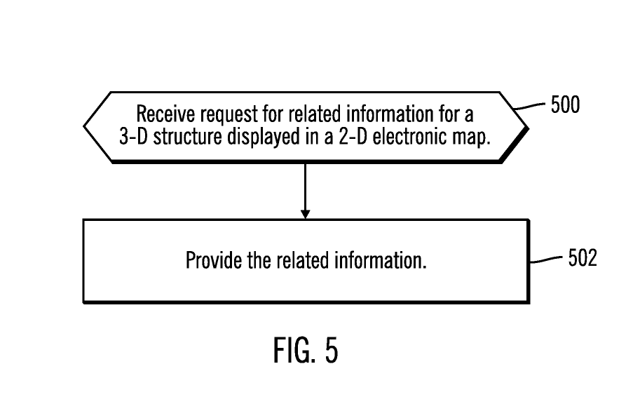

FIG. 5 illustrates, in a flow diagram, operations performed to provided related information in accordance with certain embodiments. Control begins in block 500 with the 3-D system receiving a request from a user for related information for a 3-D structure displayed in a 2-D electronic map. In certain embodiments, the user selects a related information indicator to obtain the related information. In other embodiments, a user selects the 3-D structure (e.g., by right clicking on the 3-D structure). In block 500, the 3-D system 110 provides the related information to the user.

By providing views from a specific floor of a building, the 3-D map system 110 allows visualization at the 3rd dimension (e.g., what can be seen outside of the floor). The views may be of the internals of the building or may be outside views that can be seen from inside (e.g., via a window) on the floor of the building.

Also, the 3-D map system 110 allows a user to visualize the positioning of buildings in their surroundings to picture how the location will look like. For example, a user may select any view point and see how the surrounding is, and this may help the user to select an appropriate address. The user may go to the office for work and may also enjoy the views of the surroundings.

Thus, display of the search results addresses, along with the height information, allows the user to visualize the height of the buildings very quickly and effectively. Also, display of associated information (e.g., photographs posted from the height of the building retrieved from social networking and other sites) helps the user visualize views outside the building from a particular floor. Moreover, the user may also provide height as part of the search criteria.

Given an address that specifies the floor when, the user is able to visualize the height level (e.g., what can be seen from the floor of the building). This visualization may bring useful insight to the searcher.

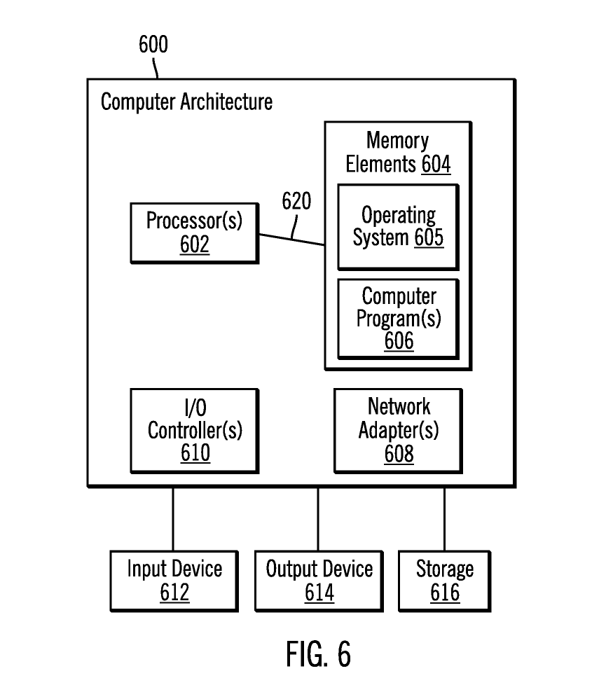

FIG. 6 illustrates a computer architecture 600 that may be used in accordance with certain embodiments. In certain embodiments, computing device 100 may implement computer architecture 600. The computer architecture 600 is suitable for storing and/or executing program code and includes at least one processor 602 coupled directly or indirectly to memory elements 604 through a system bus 620. The memory elements 604 may include local memory employed during actual execution of the program code, bulk storage, and cache memories which provide temporary storage of at least some program code in order to reduce the number of times code must be retrieved from bulk storage during execution. The memory elements 604 include an operating system 605 and one or more computer programs 606.

Input/Output (I/O) devices 612, 614 (including but not limited to keyboards, displays, pointing devices, etc.) may be coupled to the system either directly or through intervening I/O controllers 610.

Network adapters 608 may also be coupled to the system to enable the data processing system to become coupled to other data processing systems or remote printers or storage devices through intervening private or public networks. Modems, cable modem and Ethernet cards are just a few of the currently available types of network adapters 608.

The computer architecture 600 may be coupled to storage 616 (e.g., any type of storage device; a non-volatile storage area, such as magnetic disk drives, optical disk drives, a tape drive, etc.). The storage 616 may comprise an internal storage device or an attached or network accessible storage. Computer programs 606 in storage 616 may be loaded into the memory elements 604 and executed by a processor 602 in a manner known in the art.

The computer architecture 600 may include fewer components than illustrated, additional components not illustrated herein, or some combination of the components illustrated and additional components. The computer architecture 600 may comprise any computing device known in the art, such as a mainframe, server, personal computer, workstation, laptop, handheld computer, telephony device, network appliance, virtualization device, storage controller, etc.

### Additional Embodiment Details

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method, comprising:
receiving, using a processor of a computer, search criteria for an entity;
identifying one or more addresses for the entity based on the search criteria;
for each of the one or more addresses,
identifying a floor associated with the entity at that address;
identifying related information for the floor that includes photographs of views seen from that floor; and
plotting, on a 2-dimensional (2-D) electronic map, a 3-dimensional (3-D) structure that indicates the floor and provides access to the related information.

2. The method of claim 1, further comprising:
for a particular address,
determining a height based on the floor at that particular address;
searching photograph metadata for the photographs captured from that height at the particular address; and
storing the photographs as related information for the floor at that particular address.

3. The method of claim 1, further comprising:
identifying the related information for the floor using a social networking site.

4. The method of claim 1, wherein the search criteria indicates a range of floors for the address location.

5. The method of claim 1, further comprising:
receiving a request for the related information for a 3-D structure displayed in the 2-D electronic map; and
in response to receiving the request, providing the related information.

6. The method of claim 1, wherein identifying the floor includes performing another search.

7-18. (canceled)
